(19) United States
(12) Patent Application Publication
(10) Pub. No.: US 2025/0237302 A1
(43) Pub. Date: Jul. 24, 2025

(54) HOUSING AND FRAME FOR EMB ACTUATOR

(71) Applicants: ZF Active Safety US Inc., Livonia, MI (US); ZF Active Safety GmbH, Koblenz (DE)

(72) Inventors: Kraig E. Gerber, Livonia, MI (US); Michael Wozniak, Livonia, MI (US); Pascal Jung, Koblenz (DE); Markus Reinhard, Lahnstein (DE)

(21) Appl. No.: 18/419,911

(22) Filed: Jan. 23, 2024

(51) Int. Cl. F16H 57/025; F16D 65/16; F16D 121/24; F16D 125/50; F16H 57/02; F16H 57/031

(52) U.S. Cl. CPC F16H 57/025; F16D 65/16; F16H 57/031; F16D 2121/24; F16D 2125/50; F16D 2250/0076; F16D 2250/0084; F16H 2057/02034; F16H 2057/02082

(57) ABSTRACT

A frame is provided for an actuator assembly of a vehicle brake having a housing enclosing a gear stage and a motor for delivering torque to the gear stage. The frame includes a base having a first interface for connecting to the gear stage and a second interface for connecting to the motor. Projections extend outward from the first interface for receiving fasteners to secure the base directly to the housing and transfer loads from the motor to the housing during braking operations.

### TECHNICAL FIELD

The present invention relates to electromechanical brake actuators and, in particular, relates to a housing and frame for the drive assembly of the actuator.

### BACKGROUND

Carrier assemblies for brake actuators generally secure to and confine the working parts, e.g., motor and planetary gear stage, of the actuator used for service and parking braking. Consequently, the carrier assembly helps to absorb forces created during braking, such as vibrational forces, torque, and reaction forces from holding the parking brake. It is therefore desirable to provide a carrier assembly designed to optimally endure and/or distribute these operational forces.

### SUMMARY

In one example, a frame is provided for an actuator assembly of a vehicle brake having a housing enclosing a gear stage and a motor for delivering torque to the gear stage. The frame includes a base having a first interface for connecting to the gear stage and a second interface for connecting to the motor. Projections extend outward from the first interface for receiving fasteners to secure the base directly to the housing and transfer loads from the motor to the housing during braking operations.

In another example, a housing for an actuator assembly of a vehicle brake having a gear stage and a motor for delivering torque to the gear stage includes a first part for receiving the gear stage and the motor. A second part is secured to the first part for enclosing the gear stage and the motor. The second part is integrally formed with a control assembly for controlling operation of the motor.

In another example, a method is provided for forming a housing for an actuator assembly of a vehicle brake having a gear stage and a motor for delivering torque to the gear stage. The method includes providing a first part that receivers the gear stage and the motor. An interface between a wall and a control assembly for controlling operation of the motor is fused to form a second part. The second part is secured to the first part to enclose the gear stage and the motor within the housing.

Other objects and advantages and a fuller understanding of the invention will be had from the following detailed description and the accompanying drawings.

### BRIEF DESCRIPTION OF THE DRAWINGS

FIG. 1 is a schematic illustration of an example, exploded electromechanical brake actuator in accordance with the present invention.

FIG. 2 is a perspective view of a drive assembly of the actuator of FIG. 1.

FIG. 3A is a top view of a frame of the actuator.

FIG. 3B is a perspective view of a frame for the actuator.

FIG. 4 is a perspective view of a first portion of a cover for the actuator.

FIG. 5 is a top view of a second portion of the cover.

FIG. 6 is a bottom view of the second portion.

FIG. 7 is a schematic illustration of the drive assembly secured directly to the frame.

FIG. 8 is a schematic illustration of the first portion of the cover secured to the frame.

FIG. 9A is a schematic illustration of the second portion of the cover connected to the first portion.

FIG. 9B is a schematic illustration of a control assembly connected to the cover.

FIG. 10 is another example actuator in which only the frame is secured to the first portion of the housing.

FIG. 11 is schematic illustration of the second portion of the housing secured to the first portion.

FIG. 12A is a schematic illustration of another example housing.

FIG. 12B is a side view of the housing of FIG. 12A.

FIG. 12C is a bottom view of a portion of the housing of FIG. 12A.

### DETAILED DESCRIPTION

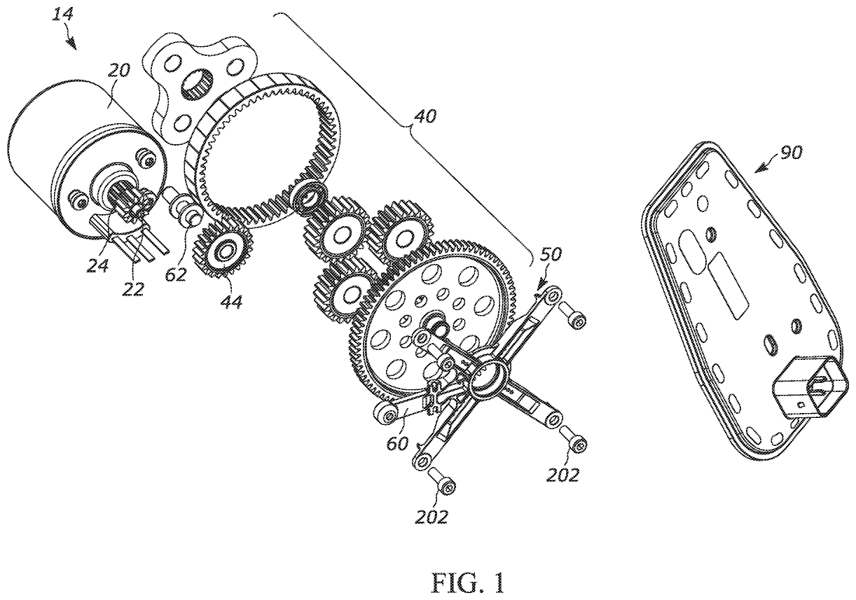

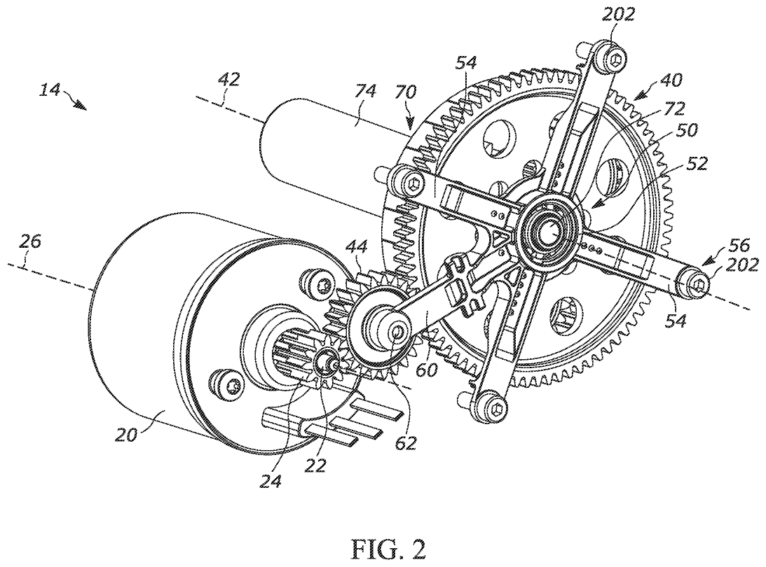

The present invention relates to electromechanical brake actuators and, in particular, relates to a housing and frame for a drive assembly of the actuator. FIGS. 1-9 illustrate an electromechanical brake (EMB) actuator or actuator assembly 10 for a vehicle in accordance with an aspect of the invention. Referring to FIGS. 1-2, the actuator 10 includes a drive assembly 14 and a control assembly 90 for controlling the same. The drive assembly 14 supplies braking force to the vehicle by converting rotation of a motor 20 into longitudinal movement of a piston 74 in a known manner.

To this end, the motor 20 has an output shaft 22 and a gear 24 rotatable with the output shaft about an axis 26. A planetary gear stage 40 is connected to the output gear 24 via one or more gears 44. As shown, a single gear 44 helps transmit torque from the output gear 24 to the planetary gear stage 40. The planetary gear stage 44 has a conventional construction centered about an axis 42 and including a sun gear, planet gears, and a carrier connected thereto that either rotate about or orbit the axis 42 in a known manner.

The planetary gear stage 40 is coupled to a spindle drive 70 that includes a spindle 72 rotatable by the planetary gear stage and a piston 74, which is axially movable in response to rotation of the spindle. The piston 74 can be connected to the spindle 72 by, for example, a ball ramp assembly, recirculating balls, etc. such that rotation of the spindle by the planetary gear stage 40 about the axis 42 causes the piston to move longitudinally along the axis. Advancing the piston 74 away from the planetary gear stage 40 applies braking force to the vehicle while retracting the piston towards the planetary gear stage reduces or releases the braking force.

A support or reinforcement member 50 is connected to the spindle drive 70 and thereby indirectly connected to the planetary gear stage 40. In particular, the spindle drive 70 is rotatably mounted, e.g., by a bearing, to a central, ring shaped hub 52 of the support member 50. Arms 54 extend radially outward from the hub 52. Each arm 54 terminates at an opening 56. As shown, four arms 54 collectively have a cross or t-shaped arrangement. An additional arm 60 extends outward from the hub 52. An axle 62 extends through the end of the arm 60 for locating and rotatably mounting the gear 44.

Returning to FIG. 1, the control assembly 90 includes conventional components for controlling and monitoring operation of the drive assembly 14, including operation of the motor 20. This can include, for example, a printed circuit board on which electrical and electronic components are arranged and are connected to one another electrically via traces. The electrical and electronic components form a speed-regulating unit for regulating the speed of the motor 20. A current measuring unit measures a current received by the motor 20. A current supply unit supplies electrical energy to the motor 20. A temperature measuring unit measures a temperature within the actuator 10. A force measuring unit measures a brake actuating force supplied by the actuator 10. A rotational position detection unit monitors a rotational position of the motor 20.

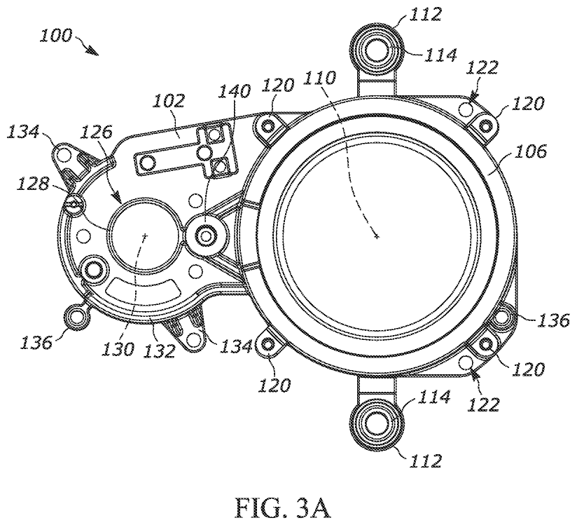

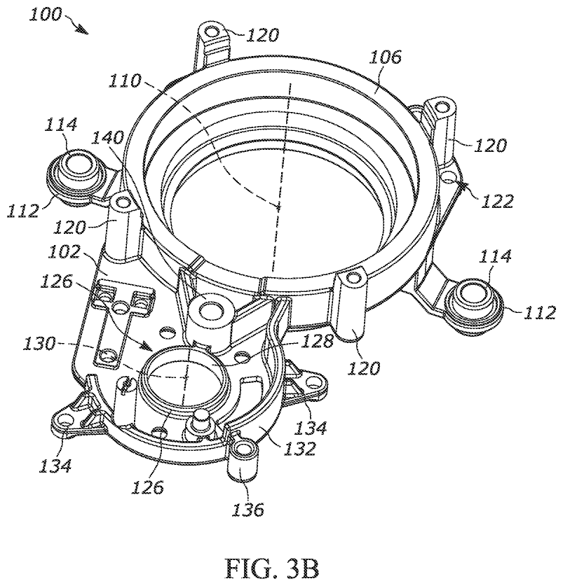

Referring to FIGS. 3A-3B, a support member or frame 100 is provided for receiving the planetary gear stage 40 and the motor 20. The frame 100 is formed as a single, unitary piece from metal, such as aluminum. The frame 100 includes a base 102 defining first and second interfaces 106, 126. The first interface 106 can be formed as a ring centered about an axis 110. Projections or projections 112 extend outward from opposing sides of the ring 106. As shown, a pair of diametrically opposed projections 112 extends outward from the ring 106. More or fewer projections 112 are contemplated as are alternative configurations for the projections.

A locating member 114 is provided on each projection 112. As shown, each locating member 114 is formed as a cylinder extending parallel to the axis 110. Connecting members 120 are circumferentially arranged about the ring 106. In one example, four connecting members 120 are equidistantly spaced around the ring 106. The connecting members 120 can be formed as threaded standoffs.

The second interface 126 can be formed as a ring defining a centering surface 128 encircling an axis 130. A flange 132 extends from the base 102 and partially around the second interface 126. Connecting members 134 are provided circumferentially around the ring 126. The connecting members 134 can be formed as projections having a passage extending therethrough. A cylindrical locating member 136 is provided adjacent each interface 106, 126. A mount or journal 140 is provided on the base 102 between and aligned with the axes 110, 130.

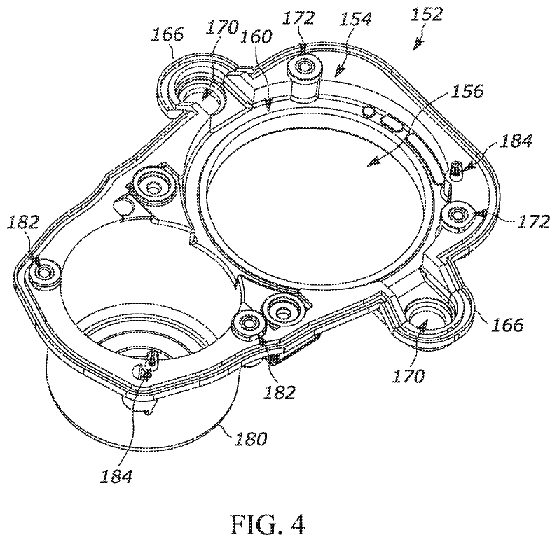

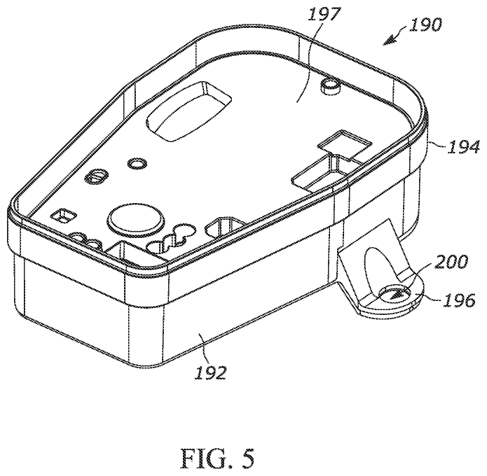

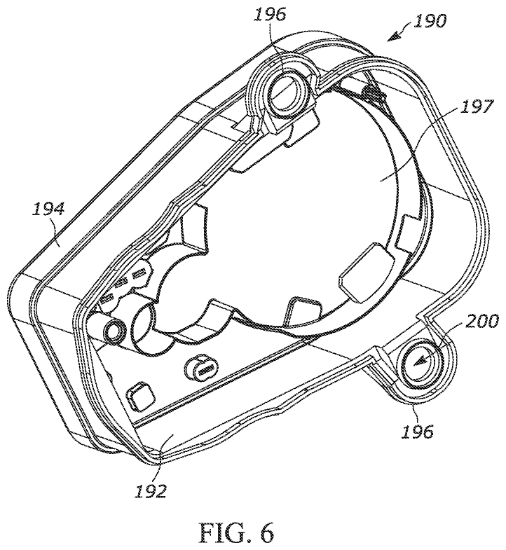

A caliper housing 150 encloses the drive assembly 14 and the frame 100 and includes a first portion or base part 152 (FIG. 4) and a second portion or cover part 190 (FIGS. 5-6). Turning specifically to FIG. 4, the first portion 152 includes a ring member 154 defining an opening 156. A recess 160 encircles the opening 156. Pockets 166 extend radially outward from the ring member 154. As shown, the pockets 166 are diametrically opposed from one another. An opening 170 extends through each pocket 166. Openings 172 are provided around the periphery of the opening 156 and adjacent to the pockets 166.

A motor cover 180 extends in a direction generally parallel to the depth of the opening 156. The motor cover 180 can be formed as a cylinder closed at one end. A series of pockets or recesses 182 are circumferentially arranged about the end of the motor cover 180. The recesses 182 can be diametrically opposed from one another.

The second portion 190 (FIGS. 5-6) includes a wall 192 having an open, polygonal shape. A peripheral rim 194 extends along the entire perimeter of the wall 192. Projections 196 extend outward from opposite sides of the wall 192. As shown, the projections 196 extend in opposite directions from one another and reside in the same plane. An opening 200 extends through each projection 196.

A bulkhead 197 is integrally formed with the wall 192 and the rim 194 and located generally at the intersection therebetween. That said, the bulkhead 197 is recessed from the top surface of the rim 194 and spans the entire footprint of the wall 192. In other words, the bulkhead 197 closes the interior of the wall 192. Forming the wall 192, rim 194, and bulkhead 197 integrally as a single, composite piece, e.g., via injection molding, alleviates the need to secure separate components together with fasteners, such as screws or adhesive, or via welding. This advantageously alleviates the need to provide a separate seal along the bulkhead/wall/rim interface(s), thereby reducing the complexity of assembly and the number of parts. At the same time, integrally forming the wall 192 and bulkhead 197 as a single piece without an interface/connection obviates the need to provide potting between the periphery of the bulkhead and interior of the wall to help join the components together.

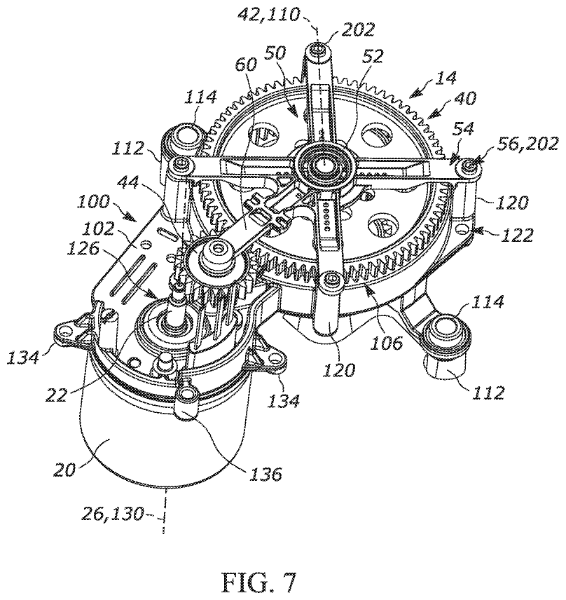

In one example shown in FIG. 7, to assemble the actuator 10, the planetary gear stage 40 is connected to the first interface 106 and the motor 20 is connected to the second interface 126. To this end, fasteners 202 extend through the openings 56 in the arms 54 of the support member 50 and into the connecting members 120 to secure the support member and, thus, secure the planetary gear stage 40 and spindle device 70 connected thereto to the frame 100. This securely fixes the planetary gear stage 40 within the first interface 106 and aligns the axes 42, 110. At the same time, the motor 20 extends into the motor cover 180 and the output shaft 22 extends through the second interface 126. The gear 44 is rotatably connected to the mount 140 such that the gear 44 is meshed with both the gear 24 and the planetary gear stage 40.

It will be appreciated that a portion of the motor 40 is received in the centering surface 128 in a manner that aligns the rotation axis 26 of the motor 20 with the axis 130 of the second fastening surface. This helps keep the axis 26 of the motor 20 parallel to the axis 42 of the planetary gear stage 40. Consequently, torque can be reliably transferred from the motor 20 to the planetary gear stage 40.

It will be appreciated that the use of a single component frame 100 helps provide a stiff mounting structure for both the planetary gear stage 40 and the motor 20. This high stiffness is maintained at higher temperatures that can occur during operation of the actuator 10.

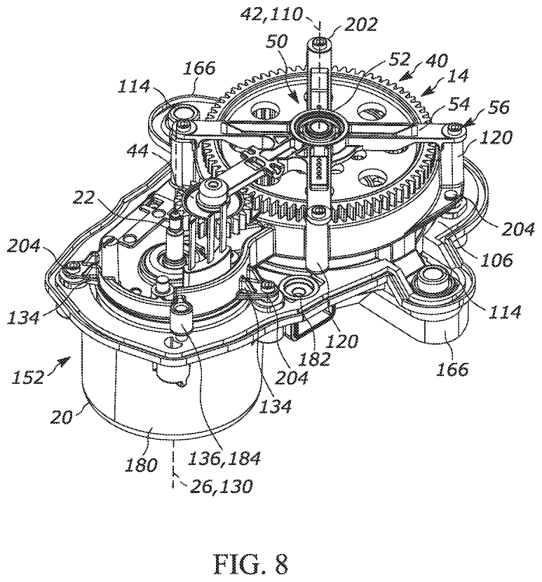

The subassembly of the drive assembly 14 and the frame 100 is then secured to the first portion 152 of the housing 150 as shown in FIG. 8. In particular, the frame 100 is orientated with the first portion 152 such that the motor 20 extends into the motor cover 180 and the first interface 106 is positioned within the recess 160. This positions the locating members 114 in the openings 170 of the housing 150. First seals 210 are provided between the pockets 166 in the first portion 152 and the projections 112. In one example, the first seals 210 are standard O-rings or integrated (two-component) seals.

At the same time, the openings 122 are aligned with the openings 172 and the connecting members 134 are aligned with the recesses 182. Fasteners 204 extend through the aligned openings 122, 172 to directly secure the first interface 106 to the first portion 152 of the housing 150. Additional fasteners 204 extend through the aligned openings 134, 182 to directly secure the second interface 126 to the first portion 152 of the housing 150. The projections 184 extend into the locating members 136.

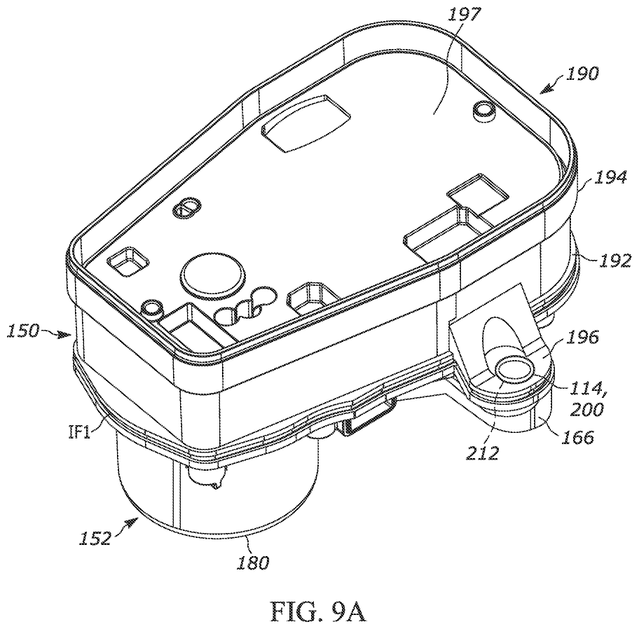

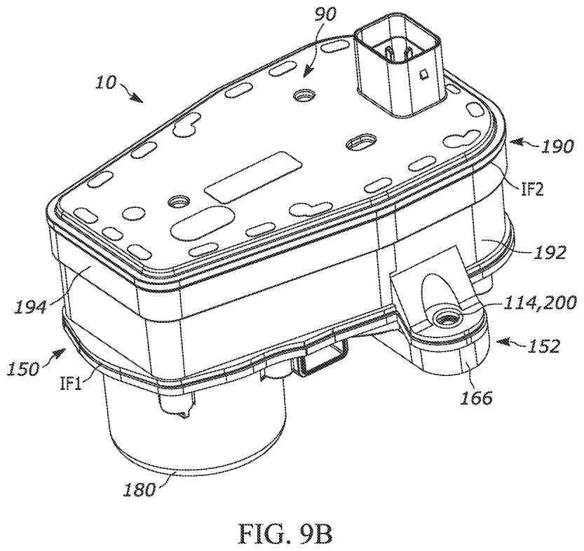

Turning to FIG. 9A, the one-piece second portion 190 is positioned over the frame 100 such that the locating members 114 on the frame extend through the openings 200 in the projections 196. Second seals 212 are provided over the locating members 114 on the frame 100 between the locating members and the projections 196 on the wall 192. The wall 192 extends around and encircles the remainder of the frame 100 while forming an interface between the periphery of the wall and the periphery of the first portion 152. The interface between the first and second portions 152, 190 of the housing 150 (indicated at “IF1”) is then fused together by, for example, welding.

The control assembly 90 is then joined to the one-piece second portion 190 (FIG. 9B) without the need for fasteners, such as screws or adhesive. Rather, the control assembly 90 is fused, e.g., via laser weld, vibratory weld or ultrasonic weld, to the rim 194 in an integrated process while covering the bulkhead 197. To this end, the peripheries of the control assembly 90 and the top surface of the rim 194 are aligned with one another along an interface (indicated at “IF2”) and welded together. This advantageously alleviates the need to provide a separate seal along the control assembly/rim interface, thereby reducing the complexity of assembly and the number of parts.

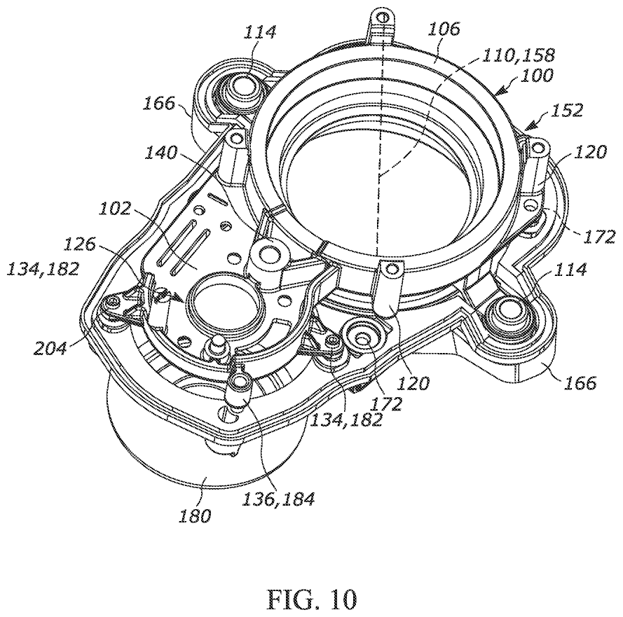

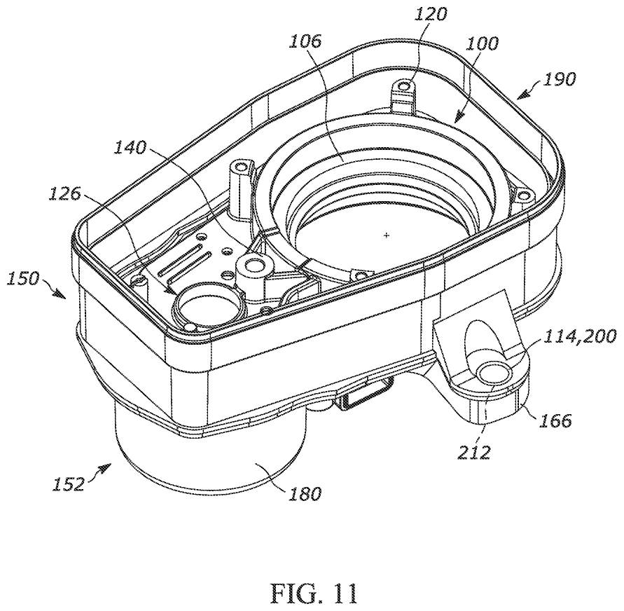

In another example shown in FIG. 10, the frame 100 is secured to the first portion 152 of the housing 150 as previously described but without first attaching the drive assembly 14 to the frame. In this this example, the control assembly 90 and second portion 190 are not pre-assembled as a single unit. Rather, and turning further to FIG. 11, the wall 192 alone is positioned over the frame 100 such that the locating members 114 on the frame extend through the openings 200. The second seals 212 are provided over the locating members 114 on the frame 100 between the locating members and the projections 196 on the wall 192. The wall 192 extends around and encircles the remainder of the frame 100 while forming an interface between the periphery of the wall and the periphery of the first portion 152. The first and second portions 152, 190 are then securely fixed directly to one another along the interface via, for example, laser welding, epoxy, etc.

Once this is accomplished, the drive assembly 14 is inserted through the first portion 152 of the cover 150 and secured directly to the frame 100 in the manner previously discussed. The bulkhead 197 (not shown here) is then inserted into and secured to the rim 194 along the interface IF as previously discussed. Finally, the control assembly 90 is inserted into and secured to the rim 194 along the interface IF2 as previously discussed to enclose the drive assembly 14 and bulkhead 197 within the housing 150.

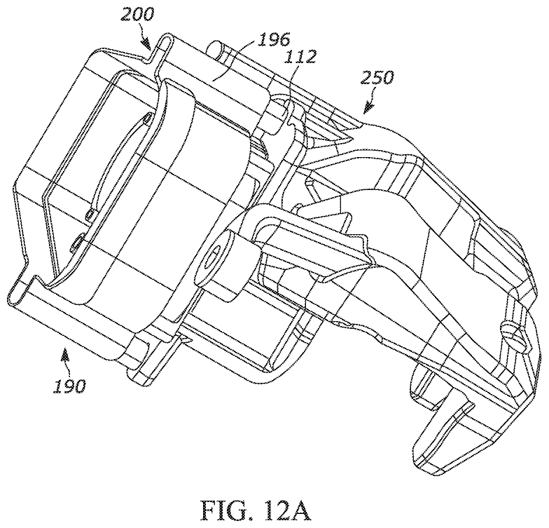

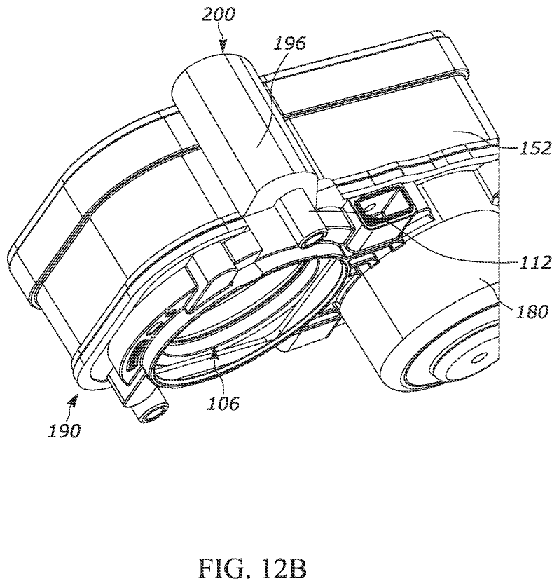

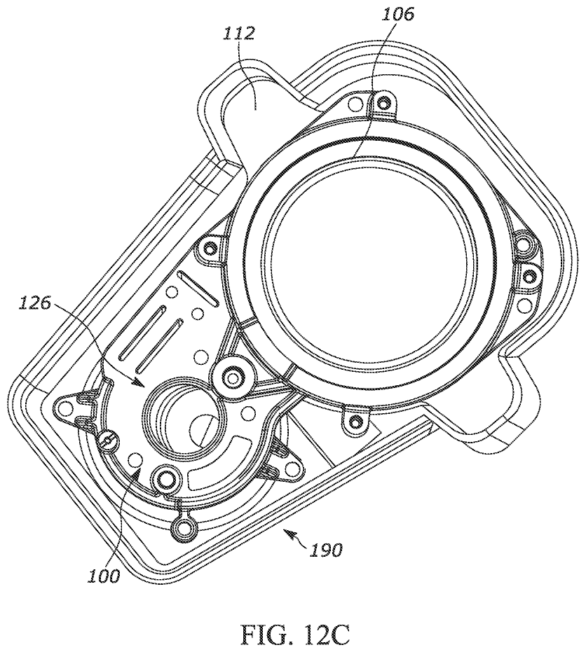

The actuator assembly 10 can be configured to be secured directly to the remainder of the brake caliper. In one example shown in FIGS. 12A-12C, the projections 196 on the wall 192 are elongated to thereby elongate the openings 200. That said, the openings 200 allow the frame 100—more specifically the projections 112—to slide through the entire depth of the projections 196 for direct connection to the caliper 250. This enables the frame 100 to transfer vibrational and other forces/stresses from the motor 20, through the projections 112, and ultimately to the caliper 250 while avoiding/mitigating transfer of any vibrational loads from the frame to the wall 192. Moreover, this advantageously allows the first and second portions 152, 190 of the housing to be integrally formed as a single piece without the need for fasteners or the like.

The present invention is advantageous because it allows the carrier assembly to redistribute reaction forces generated by the drive assembly in a manner that helps prolong the effective live of the carrier assembly. To this end, the motor is mounted directly to the frame and, thus, the frame provides a robust path for transferring vibrational loads during operation of the motor. More specifically, vibrational loads on the motor, e.g., caused by vibrations in the suspension induced by the road terrain, are transferred through the projections on the frame to the housing. Additionally, the direction connection between the frame and the motor helps to maintain the motor torque applied during application of the parking brake.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A frame for an actuator assembly of a vehicle brake having a housing enclosing the frame, a gear stage, and a motor for delivering torque to the gear stage, comprising:
a base having a first interface for connecting to the gear stage and a second interface for connecting to the motor, wherein projections extend outward from the first interface for receiving fasteners to secure the base directly to the housing and transfer loads from the motor to the housing during braking operations.

2. The frame recited in claim 1, wherein the projections are formed as one piece with the base.

3. The frame recited in claim 1, wherein the projections extend away from one another.

4. The frame recited in claim 1, wherein the projections are diametrically opposed from one another about an axis centered on the first interface.

5. The frame recited in claim 1, wherein the base is formed from metal.

6. A housing for an actuator assembly of a vehicle brake having a frame for receiving a gear stage and a motor for delivering torque to the gear stage, comprising:
a first portion for receiving the frame, the gear stage, and the motor; and
a separate second portion secured to the first portion for enclosing the frame, the gear stage, and the motor,

7. The housing recited in claim 6, wherein the first portion and the second portion include cooperating structure for receiving outwardly extending projections on the frame.

8. The housing recited in claim 6, wherein the first portion and the second portion are fused along an interface to seal the interface.

9. The housing recited in claim 6, wherein the first portion and the second portion are welded along an interface to seal the interface.

10. The housing recited in claim 6, wherein the second portion comprises an open wall and a bulkhead formed as one piece with the wall and closing the interior thereof for enclosing the frame, the gear stage, and the motor.

11. The housing recited in claim 10, wherein the intersection between the second portion and the bulkhead is free of potting.

12. The housing recited in claim 7, wherein the second portion is fused along an interface with a control assembly for controlling operation of the motor.

13. The housing recited in claim 12, wherein the second portion and the control assembly are welded along an interface to seal the interface.

14. The housing recited in claim 6, wherein the second portion includes a wall and projections extending outward from the wall for being secured to the frame of the actuator assembly bearing the gear stage and the motor.

15. A method of forming a housing for an actuator assembly of a vehicle brake having a frame, a gear stage, and a motor for delivering torque to the gear stage, comprising:
providing a first portion that receives the frame, the gear stage, and the motor;
providing a second portion having an open wall and a bulkhead formed as one piece with the wall and closing the interior thereof; and
fusing an interface between the first portion and the second portion to enclose the frame, the gear stage, and the motor within the housing.

16. The method recited in claim 15, further comprising fusing an interface between the second portion and a control assembly for controlling operation of the motor.

17. The method recited in claim 16, wherein fusing the interface comprises one of laser welding, ultrasonic welding, and vibratory welding the interface.

18. The method recited in claim 15, wherein fusing the interface comprises welding the interface between the first and second portions.
